(19) United States
(12) Patent Application Publication
(10) Pub. No.: US 2006/0195817 A1
(43) Pub. Date: Aug. 31, 2006

(54) Visual workflow modeling tools for user interface automation

(75) Inventor: Tim L. Moon, Mill Creek, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/070,049

(22) Filed: Feb. 28, 2005

(51) Int. Cl. G06F 9/44

(52) U.S. Cl. 717/104

(57) ABSTRACT

A system, engine, user interface, and methods are described for automating workflow modeling. In one implementation, definitions of objects in a hierarchical model for testing a workflow in a user interface are created, as well as test data to be used in a runtime test of the model. The definitions and the test data can be stored and then the definitions can be retrieved from storage as needed to generate multiple copies of objects for automating construction of the model or construction of a different model. A human operator can arrange visual representations of the objects into a given order on the user interface, for example, by dragging and dropping them, thereby creating the workflow to be tested without writing new code or defining new test data.

### TECHNICAL FIELD

The subject matter relates generally to computing systems and more specifically to visual workflow modeling tools for user interface automation.

### BACKGROUND

Conventional tools for creating and testing a user interface (UI) of an application, such as the dynamically changing UI of a web-based application, are difficult to implement. Many UIs are data-driven so that testing dynamic generation of the various states of the UI requires writing code for each page and manually entering test data into the code or using a cumbersome resource file. This is especially true for the UIs of workflow applications.

For workflow applications, the UIs can be difficult to test because workflow rules change constantly. Workflow UIs are designed to be data driven in order to meet changing business demands. Since parts of the UI that need to be tested are constantly changing, this makes maintaining the tests very expensive. For example, imagine a portion of a web UI that is used to collect data from a user and send the data to a web service. The data collected and the UI used to gather the data may be defined, such as by an extensible markup language (XML) file. Web pages that the user sees are dynamically generated when the user opens these pages in a browser. The pages are typically represented by a wizard that includes multiple pages requesting the user to enter five to ten data items per page. The UI generation for this web UI has to be in synchronization with the definitions of the UI in the XML file and has to be able to use specific data representing what a user would enter. These, in turn, must also be in synchronization with the XML file.

A workflow-based UI takes users through a particular business process that depends on what the user is trying to do. But changing business process requirements require changes in the workflow itself on a regular basis. So as a user progresses through the various stages of a given workflow there are typically multiple paths that can be taken based on data to be entered by the user. There may also be several steps withheld from the user until approval is received from a different user. These approvals and multiple possible paths represent business rules that are enforced by a workflow system. The business rules change over time, however, and require changes to the workflow represented by the UI.

Once there have been many UI tests developed to represent the various paths, approvals, and combinations of a workflow it is a significant amount of work to then go back and update the tests when a workflow changes. Changes typically consist of adding or removing a step in a workflow, or changing the order in which things happen. That is, each page may have to be rewritten and the test data hardcoded in each, or the resource file manually updated.

Finally, workflows are typically lengthy and often use data from one stage of a workflow in subsequent stages of the workflow. In conventional schemes, this makes it necessary to test the entire workflow in order to test a UI associated with only a small segment of the workflow.

There is a need for an UI modeling tool that provides automated unified control over the multiple aspects of UI testing and consistent integration of test data used in UI testing.

### SUMMARY

A system, engine, user interface, and methods are described for automating workflow modeling. In one implementation, definitions of objects in a hierarchical model for testing a workflow in a user interface are created, as well as test data to be used in a runtime test of the model. The definitions and the test data can be stored and then the definitions can be retrieved from storage as needed to generate multiple copies of objects for automating construction of the model or construction of a different model. A human operator can arrange visual representations of the objects into a given order on the user interface, for example, by dragging and dropping them, thereby creating the workflow to be tested without writing new code. In some circumstances, this ability to arrange the order of the objects may also save the human operator from redefining the test data, or at least give the operator an option between defining new test data and using predefined test data, if the predefined test data is compatible with the test being designed.

### BRIEF DESCRIPTION OF THE DRAWINGS

FIG. 1 is a block diagram of an exemplary system for implementing visual workflow modeling tools for user interface automation

FIG. 2 is a block diagram of an exemplary user interface modeling engine.

FIG. 3 is a diagram of an exemplary workflow hierarchical model.

FIG. 4 is a screenshot of a user interface of an exemplary states-&-pages editor.

FIG. 5 is a screenshot of a user interface of an exemplary sets editor.

FIG. 6 is a screenshot of a user interface of an exemplary scenarios editor.

FIG. 7 is a screenshot of a user interface of an exemplary data definition editor.

FIG. 8 is a screenshot of a user interface of an exemplary test case definition editor.

FIG. 9 is a screenshot of a user interface of an exemplary options editor.

FIG. 10 is a flow diagram of an exemplary method of automating workflow modeling via a user interface.

### DETAILED DESCRIPTION

### Overview

Described herein are systems, engines, user interfaces, and methods for automatic modeling and testing of user interfaces (UIs) associated with an application. In one implementation, a UI modeling engine includes a model editor for building a hierarchical model of a dynamic UI, and a model previewer for running tests of the model and gathering test results. The subject matter allows a human operator to automatically test a series of user experiences presented through a UI.

The exemplary UI modeling described herein creates a reusable definition of each object and relationship in the hierarchy of a given workflow model, and then creates sets of reusable test data for each part of a test. The model, the reusable definitions, and the sets of test data are capable of being stored. When the model is rearranged, or a part of the model is to be used in another model, the definitions and test data are retrieved from storage. The consistent definitions and data—e.g., retrieved from storage—allow reproducibility and uniformity not only across the entire model as its parts are rearranged, but also within multiple copies of individual parts of the model, when they are shared with other testers developing other models.

Defining and storing definitions and data of a UI model means that the pages of a dynamic UI being modeled do not have to be rewritten each time there is a change to the model. The ability to create the hierarchy of a UI model in well-defined pieces that can be stored and reused, allows easy automation of the testing of workflow UIs. The subject matter allows a workflow model to be expanded and modified by merely dragging and dropping objects representing pieces of the model, pathways, and relationships, within a friendly visual editing tool. New data does not have to be reentered for each change because test data is consistently defined, stored, and used uniformly to automatically populate modifications of the model. In other words, the exemplary UI modeling described herein is automatic, flexible—and fast.

### Exemplary System

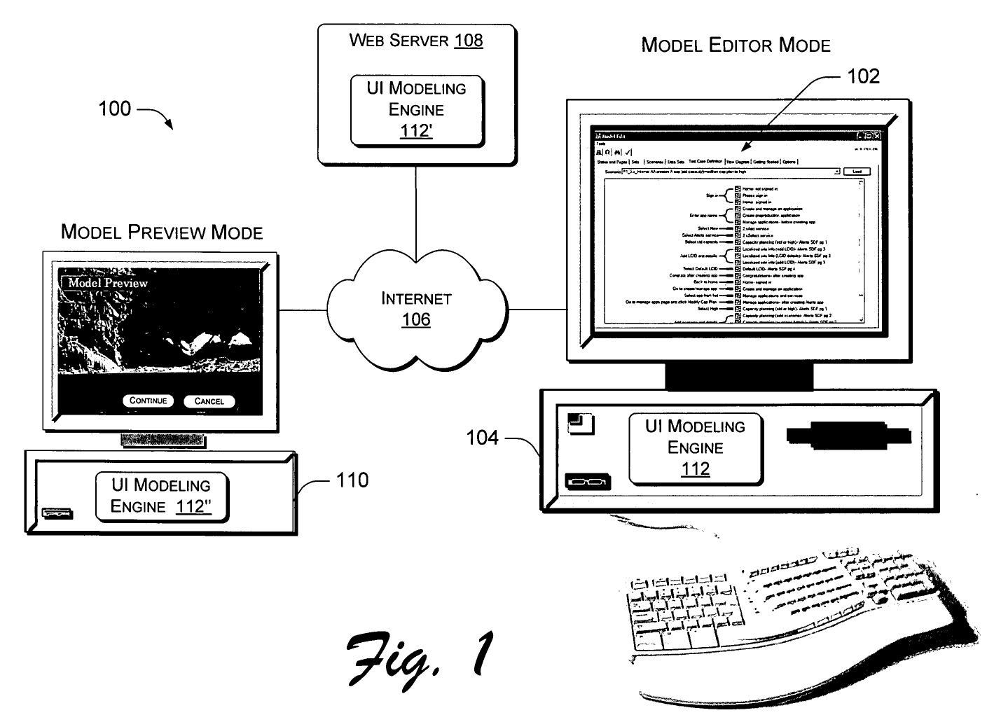

FIG. 1 shows an exemplary system 100 for automated modeling, simulating, testing, troubleshooting, etc., of a workflow via a UI 102, particularly as the UI 102 changes over time during use. A human operator's computing device 104 is coupled with a network, such as the Internet 106. The network may also include one or more servers 108 coupled with the Internet 106, and may include additional computing devices 110. One or more UI modeling engines (e.g., 112, 112′, 112″) may be used at various locations in the exemplary system 100. Although each UI modeling engine 112 can be used as a standalone tool, the UI modeling results obtained by one UI modeling engine 112 can also be shared with other UI modeling engines (112′, 112″). Likewise, a single UI modeling engine 112 may be split up into different components residing in different parts of a network. An exemplary workflow model can be developed and then shared across multiple users, e.g., so that multiple tests using a given web page share the same definition of that page. In one implementation, this provides a single point of reference for all tests so that when a change is necessary the change only has to be made in one place.

### Exemplary Engine

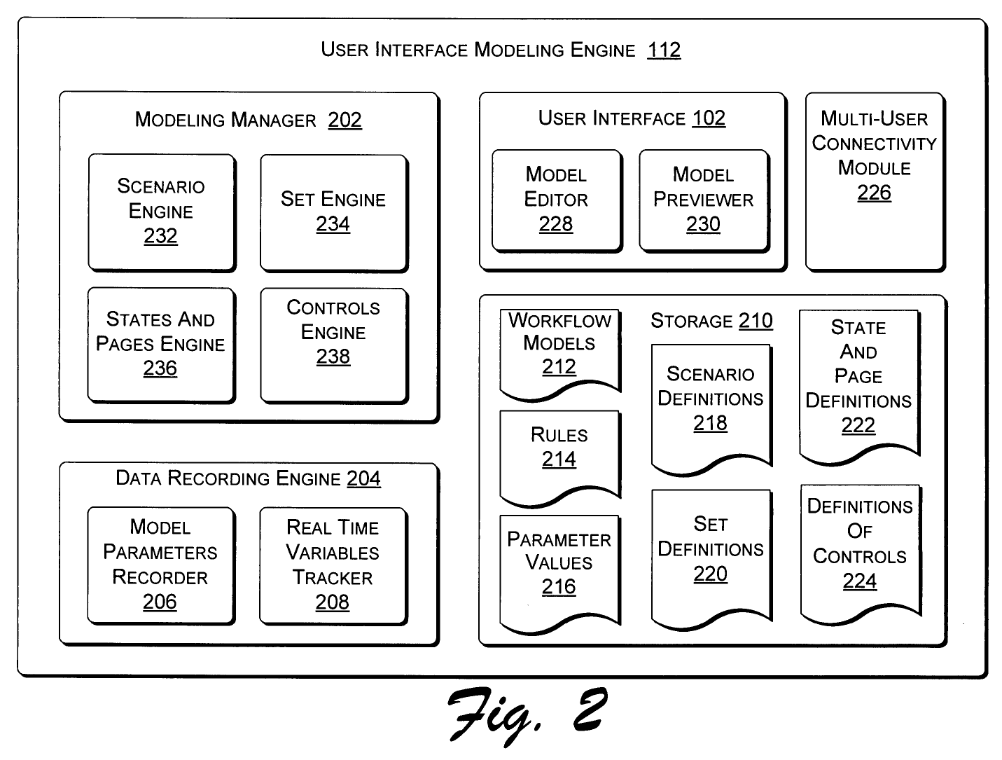

FIG. 2 shows an exemplary UI modeling engine 112 in greater detail than in FIG. 1. The illustrated UI modeling engine 112 provides one example arrangement of components. Many other arrangements are also possible for describing an exemplary UI modeling engine 112. It should be noted that an exemplary UI modeling engine 112 can be executed in hardware, software, or combinations of hardware, software, firmware, etc. An exemplary UI modeling engine 112 allows, among other things, runtime variables to be defined and data to be dynamically collected across the variables and stored for later use.

A modeling manager 202 executes the modeling and simulation of a workflow and generates associated UIs 102. The modeling manager 202 may also track the unfolding of events as the UI 102 is modeled and passes workflow parameters, UI generating parameters, and accompanying data to a data recording engine 204. During runtime of a model, the modeling manager 202 typically retrieves stored data in a particular order and performs actions defined in the data on web browser. It is worth noting that some implementations of the UI modeling engine 112 can perform workflow modeling in a different context than web based applications, for example in the context of a WINDOWS® application.

At the data recording engine 204 a parameters recorder 206 and a real time variables tracker 208 may be included to determine information to be placed in storage 210 for later reproducing a workflow carried out through the UI 102. The information stored may include workflow models 212, rules 214, parameter values 216, scenario definitions 218, set definitions 220, state and page definitions 222, and control definitions. Once in storage 210, the information for generating a particular workflow model 212 via UIs 102 can be shared with other users via a multi-user connectivity module 226. That is, other UI modeling engines (e.g., 112′, 112″) can reproduce the same workflow model or parts thereof, reproducing in turn the same parameter values and test data values used in a previous UI modeling or previously input by a user in a prior UI modeling.

A modeling manager 202, either in the same UI modeling engine 112 or in a different UI modeling engine (e.g., 112′, 112″ located remotely) can used the information residing in storage 210 to recreate a UI model, simulation, test, etc., thereby using the same data and settings as a prior user, but branching off as needed in response to new input during runtime or if a human operator decides to rearrange the UI workflow manually.

In order to modify a workflow or the UI states being generated from the workflow, an exemplary UI modeling engine 112 typically includes a model editor 228 in which the UI 102 functions as an environment for the user to edit the workflow model. A model previewer 230 executes the model, allowing the user interface 102 to function as a dynamic runtime viewer of the workflow being modeled.

In order to generate the UIs associated with a workflow, the modeling manager 202 may include a scenario engine 232 to execute scenario definitions 218 from storage 210; a set engine 234 to execute set definitions from storage; a states and pages engine 236 to execute state and page definitions 222 from storage; and a controls engine 238 to execute controls definitions 224 from storage. The modeling manager 202 not only generates UIs using the information in storage 210, but can update, modify, or add to the information in storage 210 as the UI modeling and/or UI testing progresses. In other words, the various engines of the modeling manager 202 can track each relevant parameter and datum at play during run time of an automated UI 102 and pass these to the data recording engine 204 to be placed in storage 210. Using the models, rules, values, and definitions in storage 210, a modeling manager 202 not only generates dynamically changing UIs 102 in accordance with a workflow, but also tracks information for storage 210 so that the workflow, UI modeling, and test data can be reproduced.

In one implementation, a UI modeling engine 112 includes a model editor 228 and a model previewer 230, each accessible via the UI 102. In one implementation, the model editor 228 and the model previewer 230 are built on a SQL database back end. The first tool, the model editor 228 is used to create and edit models, using the modeling manager 202 to set up a scenario with its sets, states, pages, controls, and data. The second tool, the model previewer 230 executes the model, e.g., executes tests based on the model created using the model editor 228. In one implementation, the model previewer 230 supports a web-based UI 102, however, a UI modeling engine 112 can support many types of UIs 102.

In one implementation, the UI modeling engine 112 is a MICROSOFT® WINDOWS® application providing a human operator with functionality to create and maintain a model.

### Exemplary Model Hierarchy

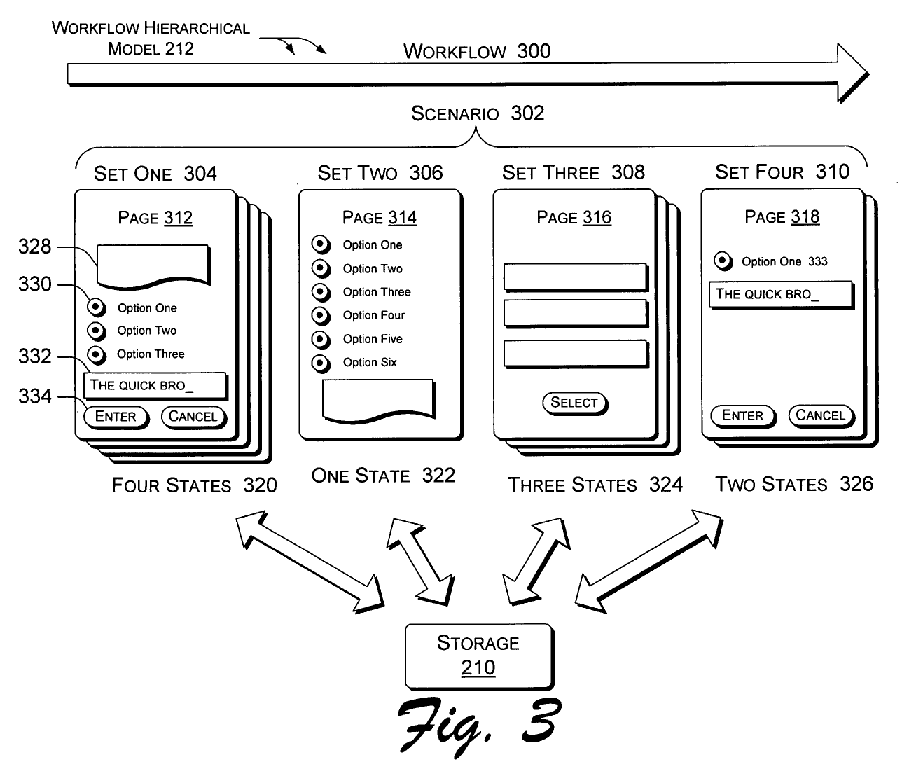

FIG. 3 shows exemplary relationships between objects, logical entities, and/or organizational techniques used in one implementation of workflow modeling, for example, using a UI modeling engine 112.

A model is a representation of a UI workflow 300 to be tested. The testing is performed on models constructed of hierarchical building blocks consisting of groups of lower level objects, as will be described below. To make a model as reusable as possible a given data value for a workflow parameter is typically tied to all levels of the hierarchical model. Additionally, workflow models may also be made more re-usable by having lower level objects reusable by other testers as they are defined. The subject matter is especially useful for modeling and testing web-based workflow systems that have data-driven UIs.

In FIG. 3, the illustrated exemplary hierarchy shows relationships between a workflow 300, a scenario 302, sets (304, 306, 308, 310), pages (312, 314, 316, 318), states (e.g., 320, 322, 324, 326) and controls (e.g., 328, 330, 332, 334) as introduced in FIG. 2. In one implementation, the modeling of a workflow 300 via a dynamically changing UI 102 can be described in terms of the interaction between a workflow 300, and the scenarios 302, sets (e.g., 304), pages (e.g., 312), states (e.g., 320) and controls (e.g., 328) that model the workflow 300.

In one implementation, a scenario 302 is the top-level representation of both a workflow 300 being tested and the data specific to a test. A workflow 300, of course, is not a static pathway through various business conditions, but is more aptly understood as a pathway through the numerous branches and forks of business possibilities. The specific pathway that becomes actualized often depends on specific data present or input in a given scenario 302 and on underlying rules 214, such as business rules, underpinning the workflow 300.

A scenario 302 can include one or more sets 304. A set 304 is a grouping of states 320 in the order they are expected to occur in the UI 102. A set 304 may include one or more states. For example, the illustrated set one 304 includes four states 320 while set two 306 includes only one state 322. Not every state included in the sets of a scenario 302 may be actuated during a given modeling run. For example, user-selection of a particular option presented in a first state of a set 304 (i.e., a set 304 that includes a page 312 with a control 330 to administer selection of the option) may immediately branch the UI flow to the next set, set two 306—without actuating the other three states in set one 304.

A state 320, then, represents the expected condition of a UI 102 at a given step in the progress through a workflow. A state 320 can include only a single page 312, which in turn is a representation of a UI 102 and typically one or more controls (e.g., 328, 330, 332, 334) that are being modeled and/or tested on the UI 102.

Controls (e.g., 328) are representations of a UI object to be deployed in the model or test. A control 328 is typically used to relay special information and/or to input user selections and data, such as a pull-down selection menu control 328, radio buttons 330, text input box 332, or selection buttons 334.

In one implementation, an exemplary UI modeling engine 112 collects data defining the different objects that make up a hierarchical model from a human operator via the UI 102 and sends it to a web service 108. Once the data has been successfully sent to the web service 108 a unique identifier (ID) is dynamically generated by a UI modeling engine 112. This ID is then used in subsequent stages of the workflow model 212. Data entered in later steps of a workflow 300 should match data entered by the user in earlier steps of the workflow model 212.

The information in storage 210, e.g., the workflow models 212, definitions, and test data can be shared across additional tests via the multi-user connectivity module 226 so that tests generated by other exemplary UI modeling engines 112 that use a given test can share the definition(s) of hierarchy parts relevant to that test. As mentioned above, this provides a single point of reference for similar tests so that when a change is called for the change need only be made in one place.

### Exemplary Model Editor

The UI model editor 228 allows a human operator (i.e., a human workflow modeler, tester, editor, architect, etc.) to build, modify, test, and maintain a model of a workflow 300. Implementations of a UI model editor 228 can perform a series of model building steps.

First, the human operator defines pages, either manually or by retrieving a stored page or page template from storage 210. Then the operator defines an order of the pages, and may group logically connected pages into sets. The operator may also retrieve a pre-made set from storage 210. Then the UI model editor 228 allows the operator to define how to progress from one page to the next. Next, the operator creates a scenario by selecting a sequence of sets, i.e., sets to be tested. The foregoing steps create the data describing a workflow model 212. If the UI modeling engine 112 tests web-based UIs, then this data can be uploaded to a central data repository of a web service 108 for uniform use across a network 106.

Next, the operator defines actual test data to be entered into the UI at each state, as the UI model progresses through a test in runtime. These data are also stored, for example, in data sets corresponding to each part of the model. These test data may also be reused at other places in the same model, for example if the same page is reused, or may be retrieved for use in a different model.

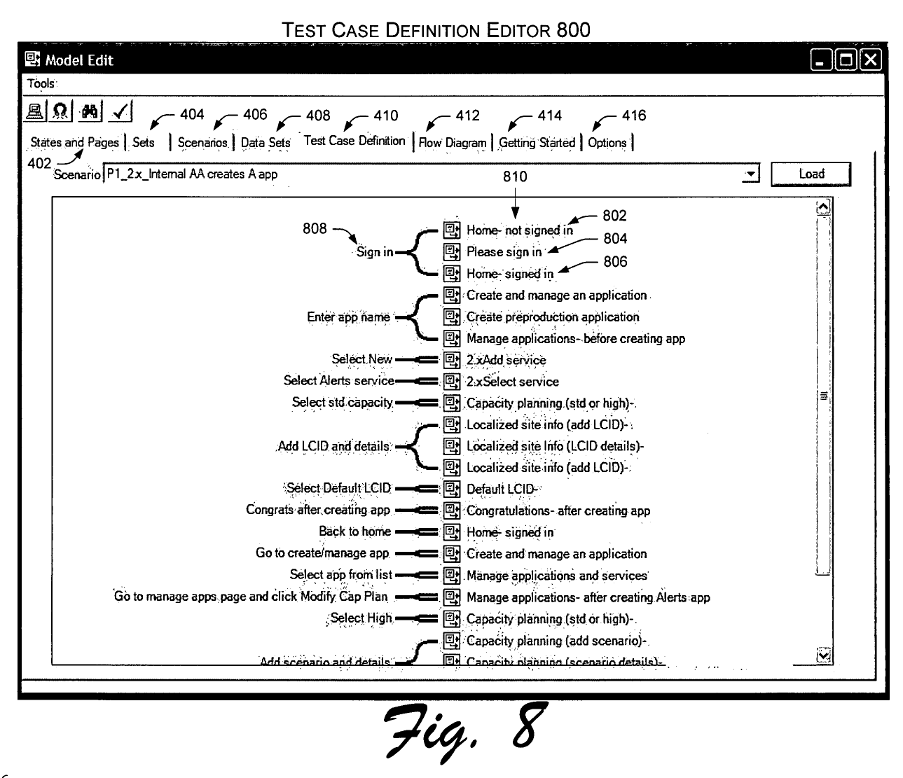

The operator may also select reporting groups for sets of the UI states that occur in sequence during a test of the workflow model. This aspect of the subject matter will be described in greater detail below, with respect to FIG. 8. In brief, a human operator working in the UI workflow editing environment can easily create adjustable brackets around sets of UI states represented as objects in the UI workflow editing environment, to obtain reports on the performance of the selected UI sets. Bracket ends are easily maneuvered by the operator to include more or fewer UI states for a given part of a report. Thus, not only is workflow setup flexible, but reporting is also flexible in a single UI environment and need not match the logical organization of the workflow setup. In other words, the human operator maintains complete control over workflow setup and reporting setup, which can follow different organizational arrangements from each other.

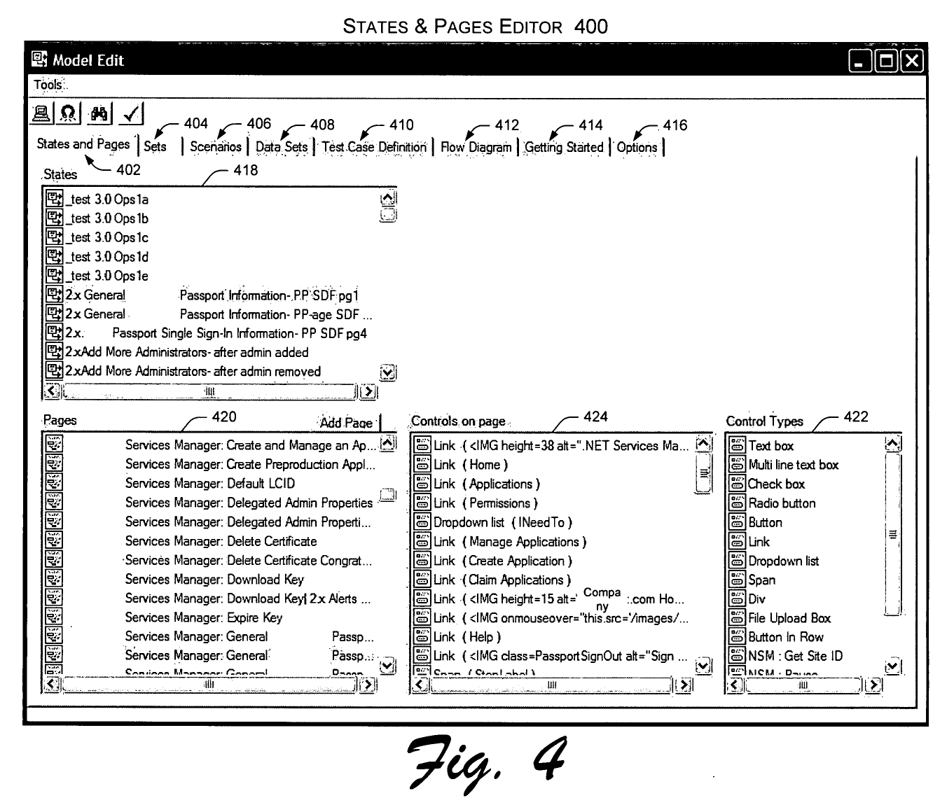

FIGS. 4-9 show one implementation of an exemplary model editor 228—that is, the exemplary UI 102 in a model edit mode. As shown in FIG. 4, the illustrated exemplary UI 102 in model edit mode consists of a tabbed interface with eight selection tabs for bringing the user's focus to each of at least five steps in an exemplary process of defining a model, plus other tabs for reporting, help, and options. Thus, multiple editors are gathered under one model editor 228, providing a menu of editing tools for building, troubleshooting, and maintaining the objects and relationships of a workflow model 212. The model editor 228 may include editing tools addressable by tabs, including a states-&-pages editor tab 402, a sets editor tab 404, a scenarios editor tab 406, a data definition editor tab 408, a test case definitions editor tab 410, and a flow diagram tab 412. The model editor 228 may also include a help resources tab 414 and an options settings tab 416. Of course, other tabs and UI controls besides tabs can be used in implementations of a model editor 228 for selecting various editing tools.

The states-&-pages editor 400 associated with the states-&-pages editor tab 402 allows a human operator to define two of the lowest level objects in an exemplary scenario 302, i.e., states 418 (e.g., 320, 322, 324, 326 of FIG. 3) and pages 420 (e.g., 312, 314, 316, 318 of FIG. 3). The states-&-pages editor 400 also provides an ability to define relationships between states 418 and pages 420. An exemplary states-&-pages editor 400 can allow an operator to define other features of states 418 and pages 420, such as available types of controls 422 and actual controls 424 (e.g., 328, 330, 332, 334) to be included on a given page (e.g., 312).

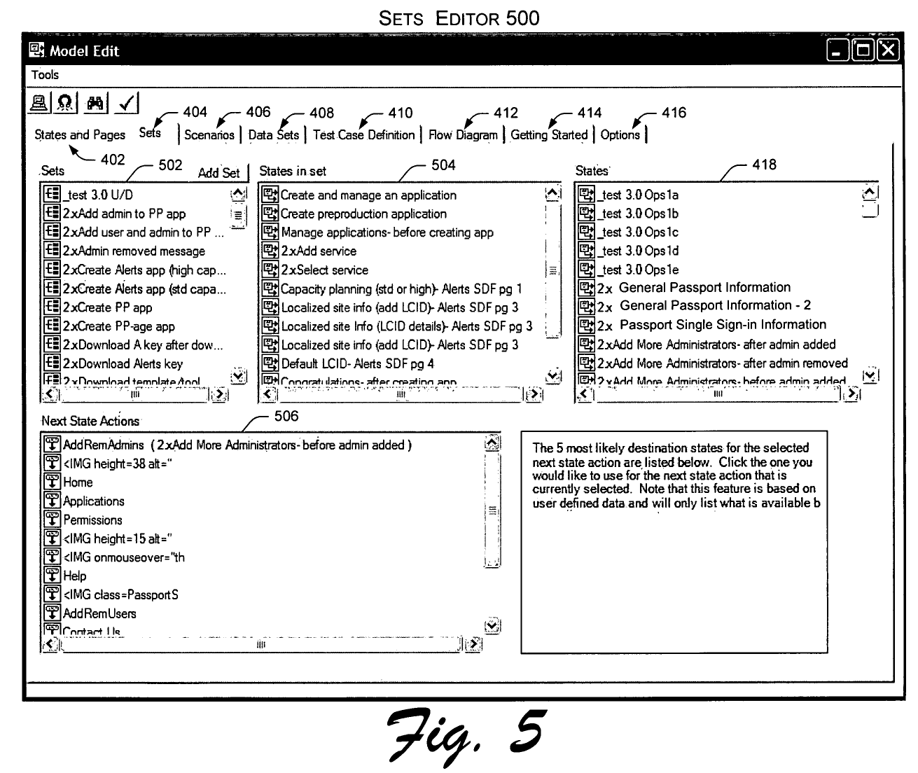

FIG. 5 shows an exemplary sets editor 500 that allows a human operator to define sets 502 (e.g., 304) and create a relationship between the sets 502 and one or more states 418 to be included in each of the sets 502, typically in a sequential order that the states 418 are expected to occur. A states-in-set pane 504 may be provided to display states 418 currently included in a selected set 502. The sets editor 500 may also provide a capability to specify which action(s) will cause one state 418 in a set 502 to progress to the next state 418 and/or given a currently selected state 418, may include a list 506 of probable next states 418.

In one implementation of an exemplary sets editor 500 (not shown), a human operator can drag and drop states 418 represented in the set editor 500 into onscreen representations of sets (e.g., 422, 424). Once a set 404 is defined by one human operator who is modeling or testing a particular functionality, the set 404 can be placed in storage 210 and shared for future tests that will use its same functionality. Such an implementation of a set editor 500 may also provides a way for the human operator to drag and drop the sets 404, like building blocks, to build a model of a workflow 300 to be tested, that is, to build a scenario 302. The human UI modeler can thus define blocks of functionality and easily change the order of workflow events or add/remove a set—a block of functionality—in the middle of a workflow 300.

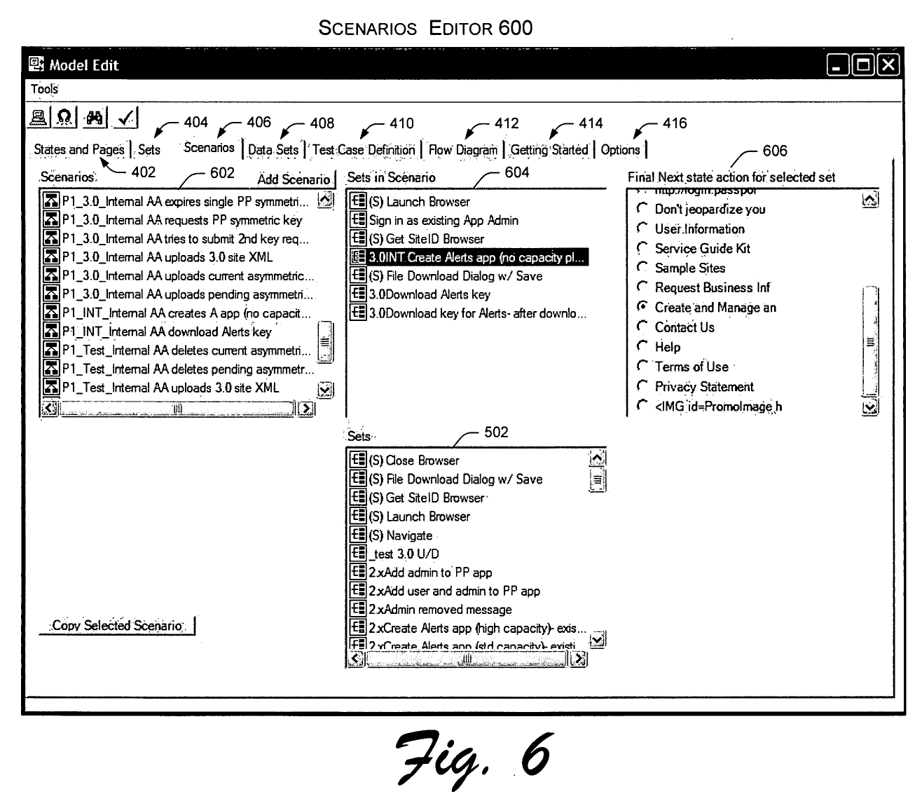

FIG. 6 shows a scenarios editor 600, which provides functionality to define scenarios 602 (e.g., 302) that include one or more sets 502 (e.g., 304, 306, 308, 310) included in each scenario 602. A sets-in-scenario pane 604 may be provided to display sets 502 currently included in a selected scenario 602. The scenario editor 600 may also provide a list of actions 606 to specify which action(s) will cause one set 502 to progress to the next set 502.

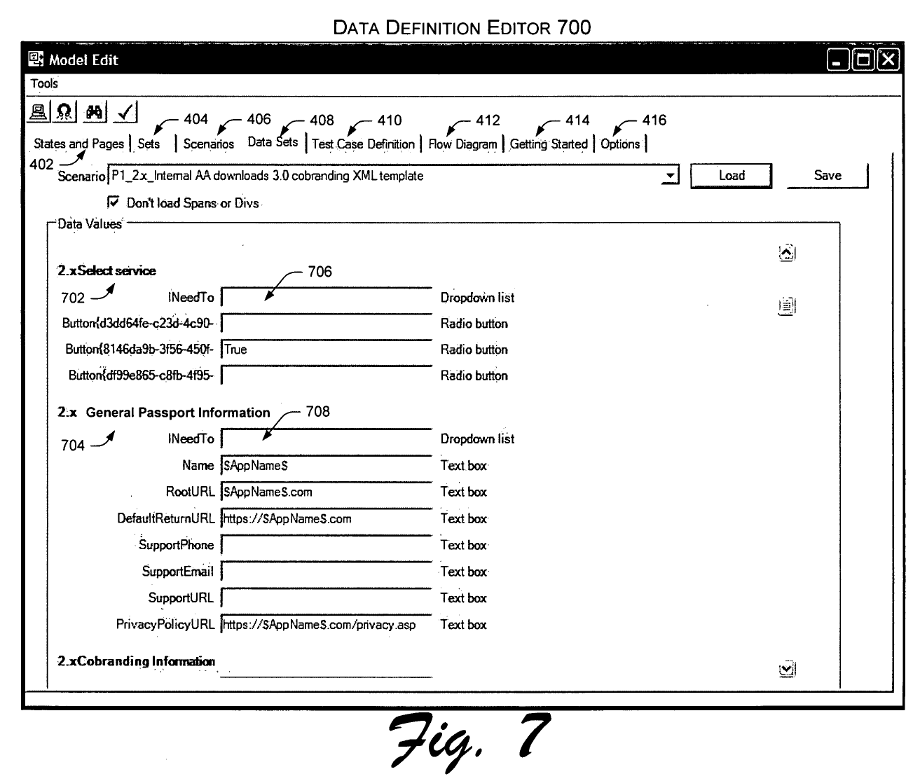

FIG. 7 shows an exemplary data definition editor 700 of the model editor 228. The data definition editor 700 can be used to create test data associated with a scenario 602. In one implementation, the data definition editor 700 dynamically generates a UI workflow based on a selected scenario 602 and controls 424 in which data can used, allowing the human operator to enter specific data values as desired. That is, to keep data consistent across multiple stages of a workflow 300, the human operator can define a specific set of test data for a scenario 602. Multiple sets of data can be swapped with each other to perform different tests on the same workflow model 212.

To allow dynamically generated data to be used at different stages of a workflow 300, runtime variables collect data while a model is executing. The data is sent to storage 210 for later use. The data definition editor 700 allows these variables to be defined by the human operator as desired. In one implementation, the data groups (e.g., 702, 704) and data fields (e.g., 706, 708) presented to the human operator are dynamically generated based on a scenario 602 that has already been defined, except perhaps the data values to be entered. Thus, the human operator simply selects and enters desired data values in the data definition editor 700, which is automatically customized to the scenario 602 being modeled.

To reiterate, once a model has been constructed, the human model builder also defines test data to be used when executing a test of the model. To make the model as re-useable as possible, a given data value may be tied to all levels of the hierarchical model, as mentioned above. For example, a model may include a page 420 in which an end user is expected to enter a user name and password. When designing a test for this page 420, the human operator may define specific test data for this particular user name and password. When this particular data is defined it is meant to be meaningful only in the context of the entire scenario 602 or hierarchy that includes the control 424 that the data will be entered in. In other words, a given data value is unique to a control 424 on a page 420 in a specific state 418 that is contained in a specific set 502 of a scenario 602. In one implementation, the data definition editor 700 highlights the relevant control for which test data is being defined, for easy visualization.

FIG. 8 shows a test case definition editor 800 for reporting test results. This editor 800 allows a human operator to create groupings of states 418 in a scenario 602 for test reporting purposes. Implementations of a test case definition editor 800 can allow a human operator to define how test results will be reported by grouping states (e.g., 802, 804, 806) into logical groups, for example, a “sign in” group 808. In one implementation, the groups are created to designate how results are to be grouped, and which pass/fail results are to be reported.

Since there is sometimes a great deal of data being defined by the human operator, the test case definition editor 800 provides an efficient visual tool for defining the groups. The editor 800 presents the user with a list 810 of all the states 418 in a given scenario 602. The states 418 can then be grouped into reporting scenarios by creating one or more named brackets, each delineating a group. In one implementation, an operator can drag the beginning and end of each bracket to encompass the appropriate list item(s) for a group. A mouse click on a list item begins creation of a new group and a double click edits the title of the new group.

In general, since building a workflow model 212 can result in a human operator defining and rearranging a significant amount of data, to make this task as efficient as possible various implementations of the UI 102 and/or editing tools support dragging and dropping objects to define the hierarchical relationships illustrated in FIG. 3, thereby giving the human operator efficient control over multiple aspects of the current workflow 300 being modeled.

It is also worth reemphasizing that at least three of the multiple editing tools of the model editor 228—the states-&-pages editor 400, the sets editor 500, and the scenarios editor 700—are usually implemented using control logic that treats all the hierarchical objects (states, pages, set, scenarios) similarly, as part of an organic hierarchy. The control logic typically uses rules 214 to define the allowed relationships between objects. In this way the same functionality can be applied to each object type with minimal additional code in the editing tools.

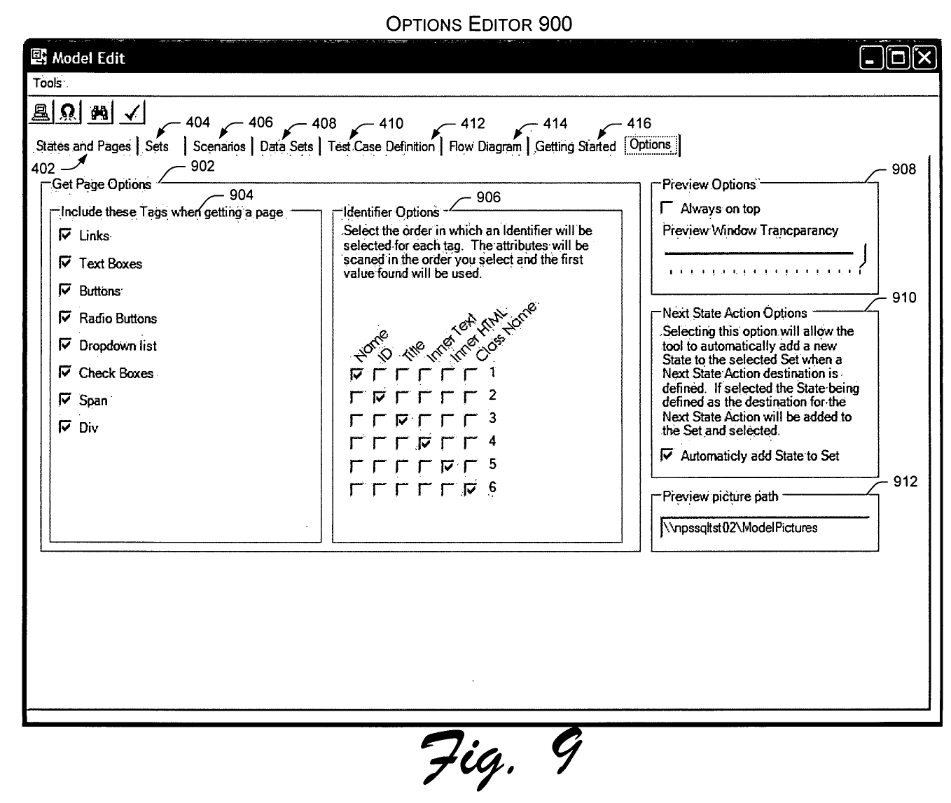

FIG. 9 shows an options editor 900 to allow a human operator to specify various preferences about how the model editor 228 and its constituent editor tools perform. For example, a get-page pane 902 can be included to select options for how the modeling manager 202 adds or copies a page 420. The get-page pane 902 may include a tags pane 904 for selecting which tags or controls to include when getting a page 420. An identifier options pane 906 may be included to select priorities for characteristics of the tags and controls to be included when the get-page options are exercised. Other examples of options that can be selected by an options editor 900 include preview options 908, next-state action options 910, a preview picture directory path 912, etc. The next-state action options 910 designate whether a new state 418 will be added to a set 502 if the new state 418 is defined as a next state action.

### Exemplary Method

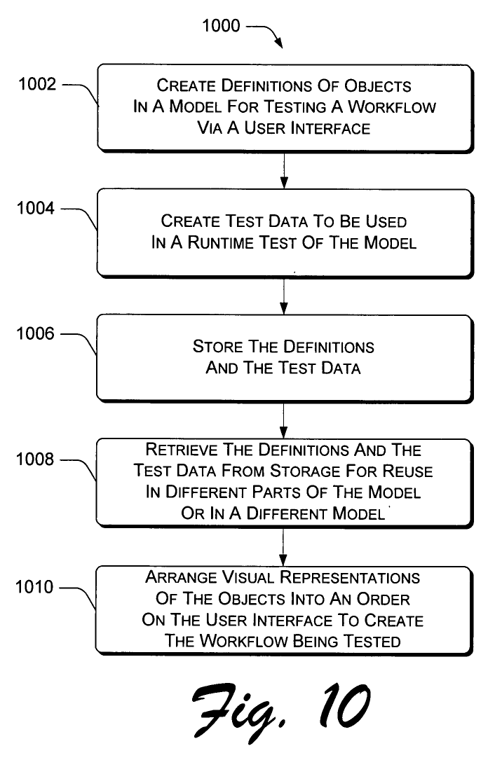

FIG. 10 depicts an exemplary method 1000 of automating testing of workflow modeling via a user interface. In the flow diagram, the operations are summarized in individual blocks. The operations may be performed by hardware, software, or combinations of both, for example, by components of an exemplary UI modeling engine 112.

At block 1002, definitions are created for objects in a hierarchical model for testing a workflow in a user interface, for example, by a modeling manager 202 of a UI modeling engine 112. The objects may include user interface pages (e.g., web pages), states of the user interface pages, sets of the states, and scenarios that include one or more of the sets. Definitions are also created for relationships in the model, for example, the hierarchical relationships between the objects, and the pathways between the states that define a workflow. Because objects of each level of a hierarchical model are defined, these definitions—that is, the objects generated from the definitions—can be used over and over within a model, without recreating each object anew each time it is used.

At block 1004, test data are created to be used in a runtime test of the model. The test data may be created in sets corresponding to types of objects used in the model, for example, each set of states may have a corresponding set of test data. Alternatively, multiple sets of test data may be created for the same model. These sets can be swapped with each other to perform different tests in the same model. A set of test data can be used at different parts of the same model, or can be used by another human operator developing another model.

At block 1006, the definitions and the test data are stored, e.g., by a data recording engine 204. The definitions may include state definitions, page definitions, set definitions, scenario definitions, relationship definitions, pathway definitions, workflow models, and business rules that specify the workflow.

At block 1008, the definitions and test data may be retrieved from storage in a particular order to regenerate the model, or a part of the model. Just as importantly, the definitions and test data may be retrieved from storage 210 to recreate certain tests or a certain behavior or branching of the workflow being modeled. The stored data and definitions may be retrieved by other model developers for use in development of different workflow models.

At block 1010, visual representations of the objects are arranged into an order on the user interface. The order of the objects, e.g., an order of states or sets, represents the workflow being tested. Thus, a model editor 228 may allow a human operator to build and/or modify a workflow model by arranging icons of the various defined pages, states, sets, and scenarios on a user interface. Each object may be replicated at will without redefining, since associated definitions and test data for the object can be retrieved from storage. The objects making up a hierarchical model are granular enough that once each object is defined, it may never have to be defined or rewritten again. Pages, states, sets, and scenarios can be used like building blocks to create a model, with their defining parameters retrievable from storage, thereby avoiding a need to rewrite these objects each time there is a change in a workflow model being tested.

### CONCLUSION

The subject matter described above can be implemented in hardware, software, firmware, etc., or combination thereof. In certain implementations, the subject matter may be described in the general context of computer-executable instructions, such as program modules, being executed by a computing device or communications device. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

The foregoing discussion describes exemplary systems, engines, user interfaces, and methods for visual workflow modeling tools for user interface automation. Although the subject matter has been described in language specific to structural features and/or methodological acts, it is to be understood that the subject matter defined in the appended claims is not necessarily limited to the specific features or acts described above. Rather, the specific features acts described above are disclosed as example forms of implementing the claims.

1. A method, comprising:
creating a definition of each object and relationship in a hierarchical model for testing a workflow in a user interface;
creating test data to be used in a runtime test of the model; and
storing the definitions and the test data, wherein the definitions and the test data are capable of being reused in different parts of the model.

2. The method as recited in claim 1, wherein at least some of the objects in the hierarchical model include user interface pages, states of the user interface pages, sets of the states, and scenarios that include one or more of the sets.

3. The method as recited in claim 2, wherein the relationships include a hierarchical order between the pages, states, sets and scenarios.

4. The method as recited in claim 2, wherein the relationships include pathways from one state to a subsequent state.

5. The method as recited in claim 2, further comprising grouping multiple states for reporting a group test result.

6. The method as recited in claim 4, wherein the grouping includes dragging ends of a visual bracket displayed on the user interface to include states from a list of states displayed on the user interface.

7. The method as recited in claim 1, further comprising retrieving a definition of one of the states, pages, sets, or scenarios from storage and using the state, page, set, or scenario in the same model.

8. The method as recited in claim 7, further comprising:
retrieving test data from storage; and
reusing the test data with the state, page, set, or scenario retrieved from storage.

9. The method as recited in claim 1, further comprising rearranging the order of objects and relationships in the model, wherein the stored test data is compatible with the rearranged model.

10. The method as recited in claim 1, further comprising expanding the model, wherein objects and relationships added to the model are retrieved from stored definitions and test data for the expanded model is retrieved from stored test data.

11. The method as recited in claim 1, wherein the definitions and the test data are capable of being reused in objects and relationships of a different model.

12. The method as recited in claim 1, further comprising collecting and storing data generated and data input during a runtime of the model.

13. The method as recited in claim 12, further comprising adding the generated data and the input data to the stored test data.

14. A user interface for implementing the method as recited in claim 1, wherein each object and relationship is assigned a visual representation in an editor mode of the user interface and the visual representations can be rearranged on the user interface to build the model.

15. The user interface as recited in claim 14, wherein:
multiple objects are generated from the stored definitions and represented as visual representations in an editor mode of the user interface, wherein each of the multiple objects comprises a reference to a single source for the test data in storage.

16. The user interface as recited in claim 15, further comprising a preview mode for providing a visual representation of a runtime test of the model.

17. A storage medium comprising a plurality of executable instructions which, when executed, implement a method according to claim 1.

18. A user interface modeling engine, comprising:
a model editor to:
define a definition of each object and relationship in a hierarchical model for testing a workflow in a user interface, and
define test data to be used in a runtime test of the model;
a data recording engine to store the definitions and the test data, wherein the definitions and the test data are capable of being reused in different parts of the model;
a modeling manager to:
build the model based on the stored definitions, the stored test data, and input from the model editor, and
execute the model in a runtime test in the user interface; and
a model previewer to display the runtime test via the user interface.

19. The user interface modeling engine as recited in claim 18, wherein:
the model editor defines at least some of the objects and at least some of the test data by retrieving definitions from storage,
the objects include user interface pages, states of the user interface pages, sets of the states, and scenarios that include at least one of the sets, and
visual representations of the objects are capable of being dragged and dropped into an order via the user interface, to create the model.

20. A system, comprising:
means for creating definitions of objects in a hierarchical model for testing a workflow in a user interface;
means for creating test data to be used in a runtime test of the model;
means for storing the definitions and the test data;
means for retrieving the definitions and the test data from storage for reuse in different parts of the model and in a different model; and
means for arranging visual representations of the objects into an order on the user interface, wherein the order represents the workflow being tested.
